(19) United States
(12) Patent Application Publication
(10) Pub. No.: US 2012/0201411 A1
(43) Pub. Date: Aug. 9, 2012

(54) AUDIO PICK-UP DEVICE OF A CONDENSER MICROPHONE

(76) Inventor: Kang-Chao CHANG, Chiayi City (TW)

(21) Appl. No.: 13/023,683

(22) Filed: Feb. 9, 2011

(51) Int. Cl. H04R 9/08

(52) U.S. Cl. 381/368

(57) ABSTRACT

An audio pick-up device of a condenser microphone includes a base, a resilient anti-shock mount disposed fixedly on the base, and an audio pick-up unit disposed securely on the anti-shock mount for sensing and processing sound waves to output corresponding electric signals. The audio pick-up device further includes a circuit unit that includes an impedance converter circuit board and a control circuit board. The impedance converter circuit board is disposed securely on the anti-shock mount and is connected electrically to the audio pick-up unit for converting a high-impedance output of the audio pick-up unit to a low-impedance output. The control circuit board is mounted on the base and is coupled electrically to the impedance converter circuit board for receiving and processing the electric signals therefrom.

### BACKGROUND OF THE INVENTION

1. Field of the Invention

The invention relates to a microphone audio pick-up device, more particularly to an audio pick-up device of a condenser microphone.

2. Description of the Related Art

A condenser microphone may include a conventional audio pick-up head mounted in a conventional anti-shock seat. The conventional audio pick-up head may be electrically coupled to an amplifying circuit board through a wire that is prone to being affected by ambient noise, which may adversely affect the sound quality of the microphone.

### SUMMARY OF THE INVENTION

Therefore, an object of the present invention is to provide an audio pick-up device of a condenser microphone that can effectively reduce the effect of ambient noise on the sound quality of the microphone.

Accordingly, an audio pick-up device of a condenser microphone of this invention includes a base, a resilient anti-shock mount disposed fixedly on the base, and an audio pick-up unit disposed securely on the anti-shock mount for sensing and processing sound waves to output corresponding electric signals. The audio pick-up device further includes a circuit unit that includes an impedance converter circuit board and a control circuit board. The impedance converter circuit board is disposed securely on the anti-shock mount and is connected electrically to the audio pick-up unit for converting a high-impedance output of the audio pick-up unit to a low-impedance output. The control circuit board is mounted on the base and is coupled electrically to the impedance converter circuit board for receiving and processing the electric signals therefrom.

The audio pick-up unit is mounted fixedly in the resilient anti-shock mount and is directly and electrically connected to the impedance converting circuit board capable of converting a high-impedance output to a low-impedance output. The audio pick-up device of a condenser microphone of this invention can thus effectively reduce noise generated by touching the audio pick-up unit through the anti-shock mount, or that is acquired from the environment. The audio pick-up device of a condenser microphone of this invention therefore significantly improves the sound quality of the microphone.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of the preferred embodiment of an audio pick-up device of a condenser microphone according to the present invention; and

FIG. 2 is an assembled sectional view of the preferred embodiment.

### DETAILED DESCRIPTION OF THE PREFERRED EMBODIMENT

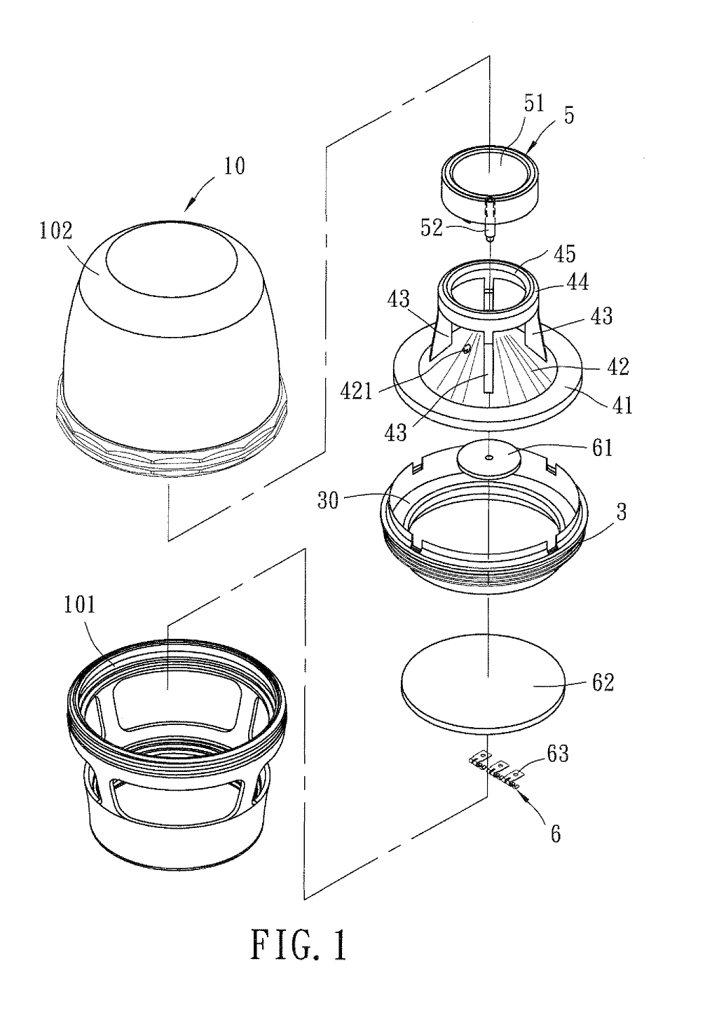

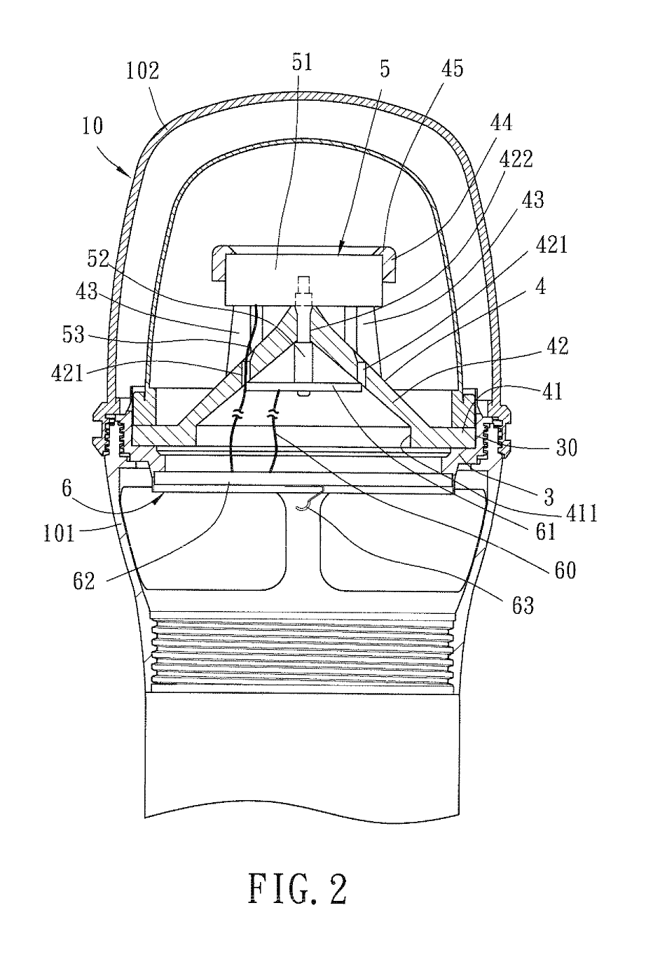

Referring to FIGS. 1 and 2, the preferred embodiment of an audio pick-up device of a condenser microphone according to the present invention is shown to be adapted to be mounted fixedly in an audio pick-up housing 10. The audio pick-up housing 10 includes a seat body 101 and a mesh cover 102 covering the seat body 101.

The audio pick-up device of a condenser microphone of this invention includes: a base 3 mounted to the seat body 101; a resilient anti-shock mount 4 mounted fixedly to the base 3; an audio pick-up unit 5 secured to the anti-shock mount 4 for sensing and processing sound waves to output corresponding electric signals; and a circuit unit 6 coupled electrically to the audio pick-up unit 5 and mounted between the base 3 and the anti-shock mount 4.

The base 3 is mounted threadedly in a top end portion of the seat body 101, and has a top side formed with an engaging groove 30.

The anti-shock mount 4 is mounted coaxially, embeddingly and fixedly in the engaging groove 30, and includes a base ring portion 41 mounting embeddingly and fixedly in the engaging groove 30, a resilient hollow cone 42 extending upwardly and inclinedly away from the engaging groove 30 and radially inward from an inner peripheral part of the base ring portion 41 that defines a central opening 411 of the base ring portion 41, a plurality of resilient support rods 43 spaced apart from one another and extending upwardly away from the engaging groove 30 from an outer peripheral part of the resilient hollow cone 42, a resilient annular top ring 44 connected to top ends of the support rods 43 distal from the resilient hollow cone 42, and a limit flange 45 extending inwardly and radially from an inner peripheral side of the top ring 44. The resilient hollow cone 42 is formed with a pair of spaced apart through holes 421, and has a top end formed with an axial hole 422.

The audio pick-up unit 5 includes a condenser unit 51 mounted embeddingly in and held resiliently by the top ring 44, and a signal terminal 52 coupled electrically and soldered fixedly to the condenser unit 51 and extending downward through the axial hole 422 of the resilient hollow cone 42. The condenser unit 51 abuts against and is limited below by a top of the resilient hollow cone 42, and abuts against and is limited above by the limit flange 45. The condenser unit 51 is used to sense ambient sound for generating a corresponding electrical signal for output. The signal terminal 52 is coupled electrically to an output end of the condenser unit 51 for transmitting the electrical signals from the condenser unit 51 to the circuit unit 6. In practice, the audio pick-up unit 5 further includes a grounding wire 53 that is coupled electrically to the condenser unit 51 and that extends downwardly through one of the through holes 421 to be coupled electrically to the circuit unit 6.

The circuit unit 6 includes an impedance converting circuit board 61 coupled electrically to and soldered fixedly to a bottom of the signal terminal 52, a control circuit board 62 coupled electrically to the impedance converting circuit board 61 through a wire 60, and an output terminal 63 coupled electrically and fixedly to the control circuit board 62. The impedance converting circuit board 61 is mounted securely in the resilient hollow cone 42 and abuts upward and resiliently against an inner wall of the resilient hollow cone 42. The control circuit board 62 is mounted embeddingly to a bottom portion of the base 3.

The term “impedance” is used for the overall collection of the resistance, the inductance, and the capacitance. The impedance of the output end of the audio pick-up unit 5 may be relatively high, such as on the order of several megaohms or gigaohms. The function of the impedance converting circuit board 61 is to convert a high-impedance output of the audio pick-up unit 5 to a low-impedance output. The signal terminal 52 directly connects and electrically couples the audio pick-up unit 5 and the impedance converting circuit board 61. In this way, interference is prevented from affecting electrical signals from the audio pick-up unit 5 under the high-impedance condition during transmission, and a low-impedance output that is more resistant to interference is generated to be transmitted to the control circuit board 62 for subsequent signal processing. Because the function of signal processing by the impedance converting circuit board 61 and the control circuit board 62 is well known in the art, it is not further detailed.

By using the signal terminal 52 to directly connect and couple electrically the audio pick-up unit 5 and the impedance converting circuit board 61, and due to the fact that the signal terminal 52 and the impedance converting circuit board 61 are all mounted in the resilient anti-shock mount 4, the high-impedance sections are effectively shielded from contact, impact, noise, and electrostatic interference. Furthermore, the high-impedance output is converted into a low-impedance output more resistant to interference, and then is transmitted to the control circuit board 62 through the wire 60. In this way, the buffering resiliency provided by the resilient anti-shock mount 4 further reduces the noise created by accidental contact or impact with the audio pick-up housing 10 or acquired from environmental conditions. Hence the sound quality of the microphone is greatly improved.

In summary, the audio pick-up unit 5 is mounted securely in the resilient anti-shock mount 4 and is directly and electrically connected to the impedance converting circuit board 61 capable of converting a high-impedance output to a low-impedance output. The audio pick-up device of a condenser microphone of this invention can thus effectively reduce noise generated by touching the audio pick-up housing 10 through the anti-shock mount 4, or that is acquired from the environment. The audio pick-up device of a condenser microphone of this invention therefore significantly improves the sound quality of the microphone.

While the present invention has been described in connection with what is considered the most practical and preferred embodiment, it is understood that this invention is not limited to the disclosed embodiment but is intended to cover various arrangements included within the spirit and scope of the broadest interpretation to encompass all such modifications and equivalent arrangements.

What is claimed is:

1. An audio pick-up device of a condenser microphone, said audio pick-up device comprising:
a base;
a resilient anti-shock mount disposed fixedly on said base;
an audio pick-up unit disposed securely on said anti-shock mount for sensing and processing sound waves to output corresponding electric signals; and
a circuit unit including
an impedance converter circuit board disposed securely on said anti-shock mount and connected electrically to said audio pick-up unit for converting a high-impedance output of said audio pick-up unit to a low-impedance output, and
a control circuit board mounted on said base and coupled electrically to said impedance converter circuit board for receiving and processing the electric signals therefrom.

2. The audio pick-up device as claimed in claim 1, wherein said base has a first side formed with an engaging groove, said anti-shock mount including
a base ring portion disposed securely in said engaging groove and formed with a central opening,
a resilient hollow cone extending away from said engaging groove and radially inward from an inner peripheral part of said base ring portion that defines said central opening,
a plurality of resilient support rods spaced apart from one another and extending away from said engaging groove from an outer peripheral part of said resilient hollow cone, each of said support rods having a first end connected to said resilient hollow cone and a second end disposed distal from said resilient hollow cone, and
a resilient annular top ring connected to said second ends of said support rods,
said audio pick-up unit including a condenser unit disposed securely in said top ring, and a signal terminal coupled electrically to said condenser unit and extending away from said condenser unit through a peak of said resilient hollow cone, and
said impedance converter circuit board being disposed securely in said resilient hollow cone, and coupled electrically to said signal terminal.

3. The audio pick-up device as claimed in claim 2, wherein said anti-shock mount further includes a limit flange extending inwardly and radially from said top ring, said condenser unit being disposed abuttingly between said resilient hollow cone and said limit flange.
